(19) United States
(12) Patent Application Publication
(10) Pub. No.: US 2026/0338606 A1
(43) Pub. Date: Oct. 29, 2026

(54) ELECTROMAGNETIC WAVE SENSOR, MOVEABLE MACHINE, FLYABLE MACHINE, AUTOMOBILE, AND TWO-WHEELED VEHICLE

(71) Applicant: TDK Corporation, Tokyo (JP)

(72) Inventors: Shinji HARA, Tokyo (JP); Tadao SENRIUCHI, Tokyo (JP); Koki KAWAMURA, Tokyo (JP)

(73) Assignee: TDK Corporation, Tokyo (JP)

(21) Appl. No.: 19/652,561

(22) Filed: Apr. 20, 2026

(30) Foreign Application Priority Data
Apr. 24, 2025 (JP) 2025-072551

(51) Int. Cl. G01J 5/20; G01J 5/00; G01J 5/08; B62J 45/41; B64D 45/00

(52) U.S. Cl. CPC G01J 5/20; G01J 5/0025; G01J 5/0859; B62J 45/41; B64D 45/00; G01J 2005/0077; G01J 2005/202

(57) ABSTRACT

An electromagnetic wave sensor comprises first wirings that extend in a first direction, second wirings that extend in a second direction that is different from the first direction, and bolometers. Each of the bolometers is electrically connected to one of the first wirings and one of the second wirings. In a third direction that is orthogonal to the first and second directions, the first wirings are on a side of incidence of incident electromagnetic waves with respect to the bolometers, and positions of the bolometers in the third direction are between positions of the first wirings in the third direction and positions of the second wirings in the third direction. The electromagnetic wave sensor is configured such that a direction in which the first wirings extend is substantially parallel to a ground surface.

### FIELD

This application claims the benefit of Japanese Priority Patent Application No. 2025-072551 filed on Apr. 24, 2025, the entire contents of which are incorporated herein by reference.

The present disclosure relates to an electromagnetic wave sensor, a moveable machine, a flyable machine, an automobile, and a two-wheeled vehicle.

### BACKGROUND

WO 2019/171488 A1 describes an electromagnetic wave sensor that comprises electromagnetic wave detection elements arranged in a two-dimensional array, first wirings that extend in a first direction, and second wirings that extend in a second direction that is orthogonal to the first direction. Each electromagnetic wave detection element is electrically connected to one of the first wirings and one of the second wirings.

### SUMMARY

The electromagnetic wave sensor of the present disclosure comprises first wirings that extend in a first direction, second wirings that extend in a second direction that is different from the first direction, and bolometers. Each of the bolometers is electrically connected to one of the first wirings and one of the second wirings. In a third direction that is orthogonal to the first and second directions, the first wirings are on a side of incidence of incident electromagnetic waves with respect to the bolometers, and positions of the bolometers in the third direction are between positions of the first wirings in the third direction and positions of the second wirings in the third direction. The electromagnetic wave sensor is configured such that a direction in which the first wirings extend is substantially parallel to a ground surface.

### BRIEF DESCRIPTION OF THE DRAWINGS

The accompanying drawings are included to provide a further understanding of the disclosure and are incorporated in and constitute a part of this specification. The drawings illustrate example embodiments and together with the specification explain the principles of the technology.

FIG. 1A is a schematic side view of an automobile provided with an infrared camera;

FIG. 1B is a schematic side view of a two-wheeled vehicle provided with an infrared camera;

FIG. 2 is an enlarged cross-sectional view of areas A in FIGS. 1A and 1B;

FIG. 3 is a front view of the infrared sensor according to the present embodiment;

FIG. 4 is an enlarged cross-sectional view of area B in FIG. 2;

FIG. 5 is a partial plan view of the infrared sensor;

FIGS. 6A to 6C are partial cross-sectional views of the infrared sensor;

FIG. 7 is an enlarged cross-sectional view of area C of FIG. 6B;

FIGS. 8A and 8B are diagrams showing concepts of infrared polarization and polarization filters;

FIGS. 9A and 9B are front views of modifications of the infrared sensor; and

FIG. 10 is a schematic side view of a drone provided with an infrared camera.

### DETAILED DESCRIPTION

Depending on installation conditions of the electromagnetic wave sensor, not only may the electromagnetic waves to be detected be directly incident to the electromagnetic wave detection elements but also reflected waves generated when electromagnetic waves from a detection target are reflected by the ground surface and then incident to the electromagnetic wave detection elements. However, reflected waves may sometimes reduce the accuracy of detecting the detection target or the accuracy of comprehending the condition of the ground surface.

It is desirable to provide an electromagnetic wave sensor capable of reducing reflected waves incident to electromagnetic wave detection elements.

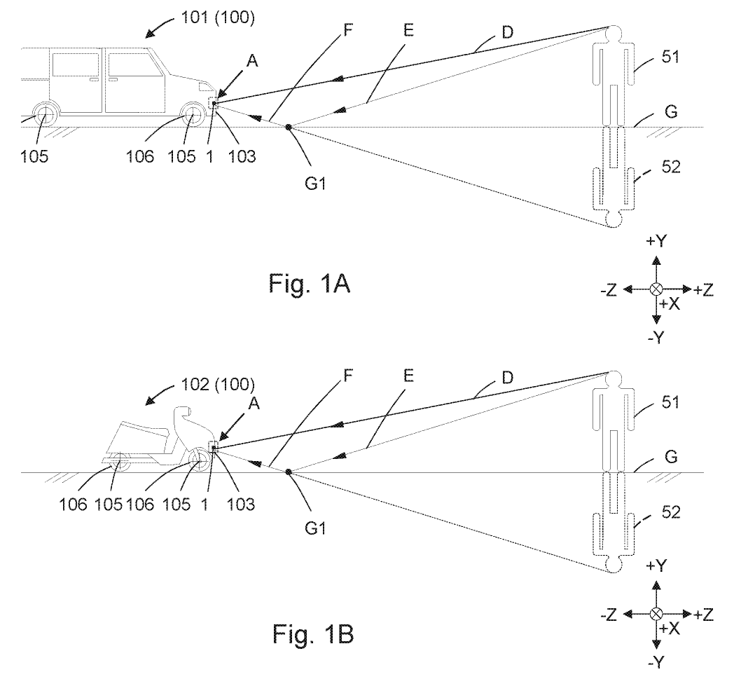

Embodiments of an electromagnetic wave sensor of the present disclosure as well as moveable machines provided with an electromagnetic wave sensor, for example, an automobile and a two-wheeled vehicle provided with an electromagnetic wave sensor, are next described with reference to the drawings. The drawings are schematic diagrams illustrating the present disclosure, and in some cases, the shapes and dimensions of the elements in the drawings may not necessarily be consistent. In particular, ground surface G is shown conceptually, and with the exception of FIGS. 1A and 1B, the spacing shown between elements may be different than the actual spacing. In the following description and drawings, the X-direction (also referred to as the “first direction”) and the Y-direction (also referred to as the “second direction”) are parallel to principal surface 11A of first substrate 11 and principal surface 12A of second substrate 12. Principal surface 11A is the surface of first substrate 11 that faces second substrate 12. Principal surface 12A is the surface of second substrate 12 that faces first substrate 11. In the present embodiment, the X-direction and the Y-direction are orthogonal to each other, but the Y-direction can be any direction different from the X-direction. The Z-direction (also referred to as the “third direction”) is orthogonal to the X-direction and the Y-direction and is perpendicular to principal surface 11A of first substrate 11 and principal surface 12A of second substrate 12. The Z-direction may also be referred to as the film thickness direction of electromagnetic wave detection elements. As shown in the drawings, the X-direction may be distinguished as the +X-direction and the −X-direction, the Y-direction as the +Y direction and the −Y-direction, and the Z-direction as the +Z-direction and the −Z-direction. The +Z-direction is the direction from first substrate 11 toward second substrate 12, and the −Z-direction is the direction from second substrate 12 toward first substrate 11.

The electromagnetic wave sensor of the present disclosure mainly detects electromagnetic waves such as infrared rays. The electromagnetic waves to be detected may be, for example, terahertz waves with wavelengths of 100μm to 1mm. The following embodiments are directed to an infrared sensor in which electromagnetic wave detection elements (bolometers) are arranged in a two-dimensional array. The infrared sensor mainly detects long-wavelength infrared rays. The wavelength of long-wavelength infrared rays is approximately 8 to 14μm. In the present embodiment, an infrared camera provided with an infrared sensor is mounted on an automobile, a two-wheeled vehicle, or other machine that can be driven, and is used mainly for both detecting people and objects at night and in dark places and ascertaining road surface conditions. In the following description, the electromagnetic wave detection elements will be referred to as infrared detection elements 15 and the electromagnetic wave sensor will be referred to as infrared sensor 2.

### Infrared Camera

FIGS. 1A and 1B show schematic side views of moveable machine 100 on which infrared camera 1 provided with infrared sensor 2 of the present embodiment is mounted. FIG. 1A shows a side view of automobile 101 which is an example of moveable machine 100, and FIG. 1B shows a side view of two-wheeled vehicle 102 which is another example of moveable machine 100. Ground surface G is assumed to be flat and level but may be uneven or sloping. Automobile 101 and two-wheeled vehicle 102 comprise wheels 105 (e.g., tires of automobile 101 and two-wheeled vehicle 102) that are in contact with ground surface G and axles 106 (e.g., axles of automobile 101 and two-wheeled vehicle 102) that support wheels 105 in a rotatable manner. Automobile 101 may include a passenger car, truck, or bus, as well as a special vehicle such as a fire truck. Two-wheeled vehicle 102 is a motorcycle in this example but may also be a scooter or a bicycle. Other self-propelled automobiles and machines that are not classified as automobiles 101 or two-wheeled vehicles 102 (tractors and other agricultural machinery, bulldozers and other construction equipment, forklifts, tricycles, automatic delivery robots for delivering packages and goods, self-propelled wheelchairs, and other automobiles and machines that can run on motors, batteries, or other power sources) are also encompassed by the term moveable machine 100.

Infrared camera 1 is mounted on front panel 103 of automobile 101 or two-wheeled vehicle 102. The position of infrared camera 1 is not limited to the front of automobile 101 or two-wheeled vehicle 102 but may be on the side or rear, and two or more infrared cameras 1 may be mounted in different portions of automobile 101 or two-wheeled vehicle 102. Although not shown in the drawings, a display panel may be mounted in front of the driver’s seat that shows the images captured by infrared camera 1.

In the present embodiment, for the sake of convenience of explanation, the X-direction and Z-direction are parallel to ground surface G, and the Y-direction is orthogonal to ground surface G. However, the Y-direction may be tilted with respect to the direction orthogonal to ground surface G, and the Z-direction may be tilted with respect to the direction parallel to ground surface G. In other words, in the present embodiment, infrared camera 1 is mounted on automobile 101 or two-wheeled vehicle 102 such that principal surface 11A of first substrate 11 and principal surface 12A of second substrate 12 are orthogonal to ground surface G, but principal surface 11A of first substrate 11 and principal surface 12A of second substrate 12 are tilted with respect to a plane orthogonal to ground surface G (i.e., in an upward or downward orientation). However, as described below, infrared camera 1 is mounted on automobile 101 or two-wheeled vehicle 102 such that the X-direction is approximately parallel to ground surface G.

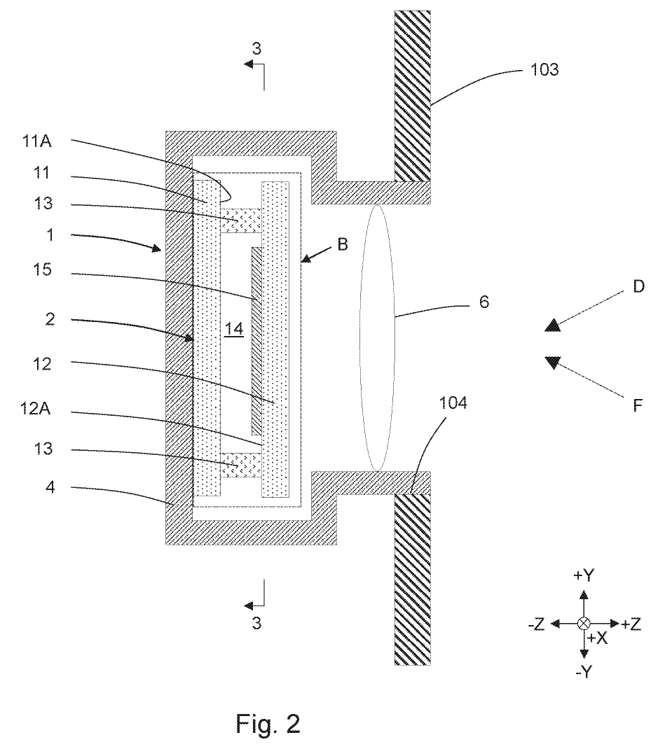

FIG. 2 is an enlarged cross-sectional view of areas A in FIGS. 1A and 1B. Opening 104 is provided in front panel 103 of automobile 101 or two-wheeled vehicle 102, and infrared camera 1 is provided inside front panel 103. Infrared camera 1 comprises infrared sensor 2, lens 6 on the +Z-side of infrared sensor 2 (the side of incidence of incident infrared rays) that collects the infrared rays, and housing 4 that houses infrared sensor 2 and lens 6. Opening 104 is provided on automobile 101 or two-wheeled vehicle 102 at a position from which the forward direction of automobile 101 or two-wheeled vehicle 102 is visible, and housing 4 is attached to front panel 103 along opening 104.

### Infrared Sensor 2

Infrared sensor 2 comprises first substrate 11 and second substrate 12 that are arranged opposite each other, and side walls 13 that both connect and encircle first substrate 11 and second substrate 12 in the circumferential direction. First substrate 11, second substrate 12, and side walls 13 form sealed internal space 14. Internal space 14 is provided with infrared detection elements 15 that function as the sensing parts of infrared sensor 2. Infrared detection elements 15 absorb and detect incident electromagnetic waves (in the present embodiment, infrared rays). Infrared detection elements 15 are bolometers. Because internal space 14 is under negative pressure or in a vacuum, this configuration can prevent or reduce convection of gases in internal space 14 and thus reduce the thermal effect upon infrared detection elements 15.

First substrate 11 is formed mainly of a silicon substrate. First substrate 11 is equipped with internal wirings (not shown) and electrical circuits such as readout ICs (ROICs) that read the output signals of infrared detection elements 5. Pads (not shown) are formed on the outer sides of side walls 13 of first substrate 11 for input from and output to the outside. The pads are electrically connected to electrical circuits by internal wirings. Second substrate 12 is also formed mainly of a silicon substrate. Second substrate 12 is the substrate on the side of incidence of incident infrared rays to be detected and supports infrared detection elements 15. Second substrate 12 transmits the infrared rays and thus allows the incidence of the infrared rays to infrared detection elements 15. First substrate 11 and second substrate 12 may be germanium substrates that transmit the infrared rays.

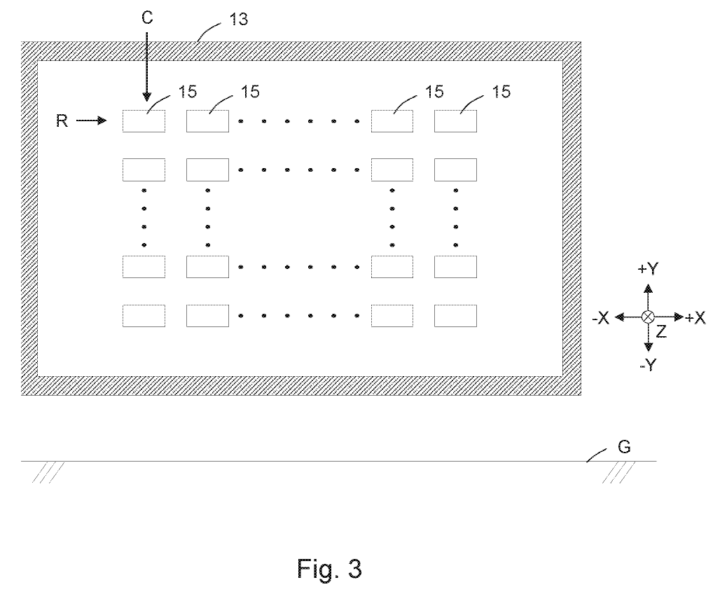

FIG. 3 is a front view of infrared sensor 2 viewed along line 3−3 of FIG. 2, shows infrared detection elements 15 and side walls 13, but does not show first wirings 19X, second wirings 19Y, first arm parts 21A, or second arm parts 21B. Infrared detection elements 15 are arranged in a two-dimensional grid-like array arrangement that comprises rows R parallel to the X-direction and columns C parallel to the Y-direction. Temperature sensing film 16 (to be described hereinbelow) of each infrared detection element 15 in this array constitutes one cell or pixel. In the present embodiment, infrared sensor 2 is mounted on automobile 101 or two-wheeled vehicle 102 such that rows R are approximately parallel to ground surface G and the number of columns C is greater than the number of rows R. The image captured by infrared camera 1 has a horizontally elongated shape when viewed from a direction in which the X-direction is the left-right direction. The numbers of rows and columns in the array include, but are not limited to, for example, 240 rows by 320 columns, 480 rows by 640 columns, or 768 rows × 1024 columns.

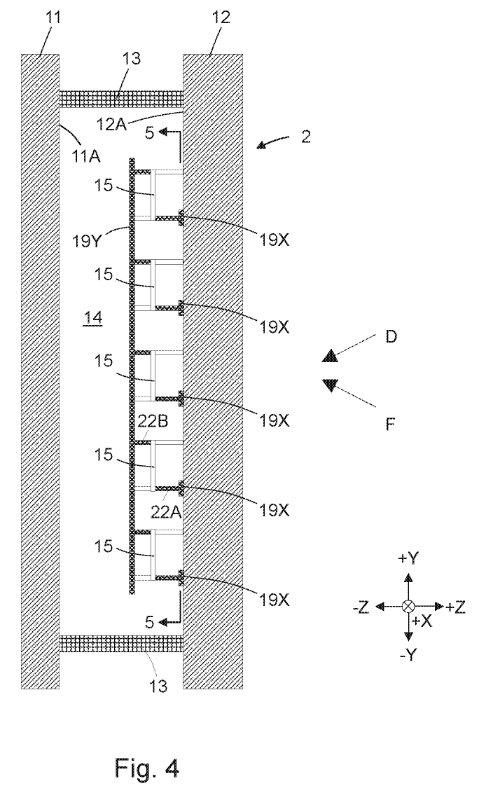

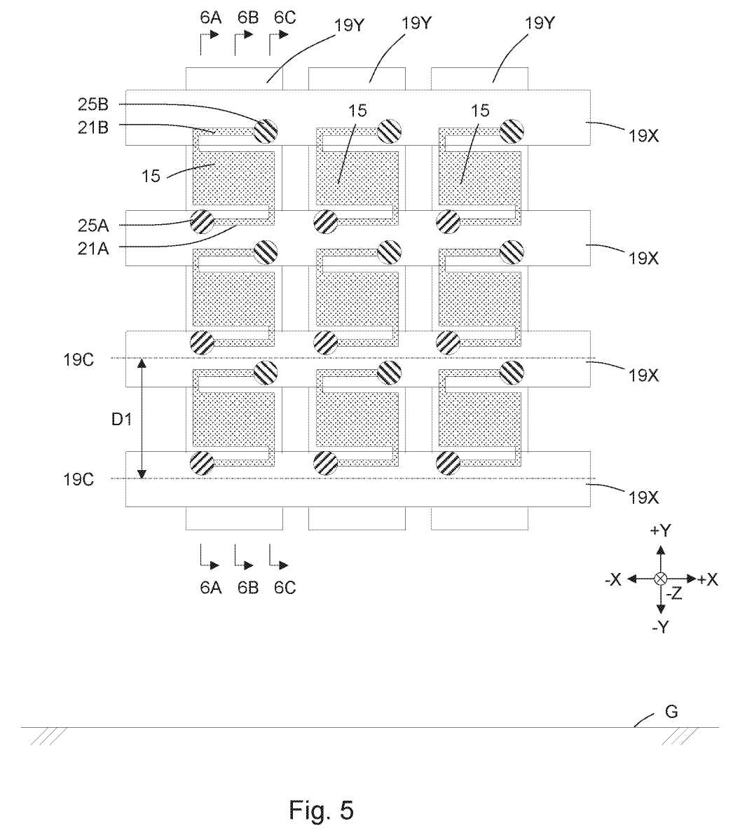

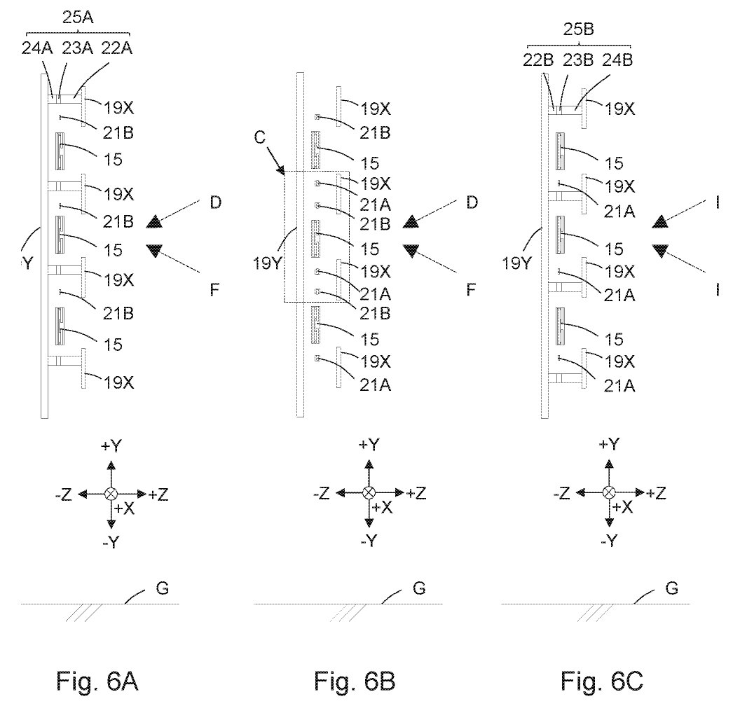

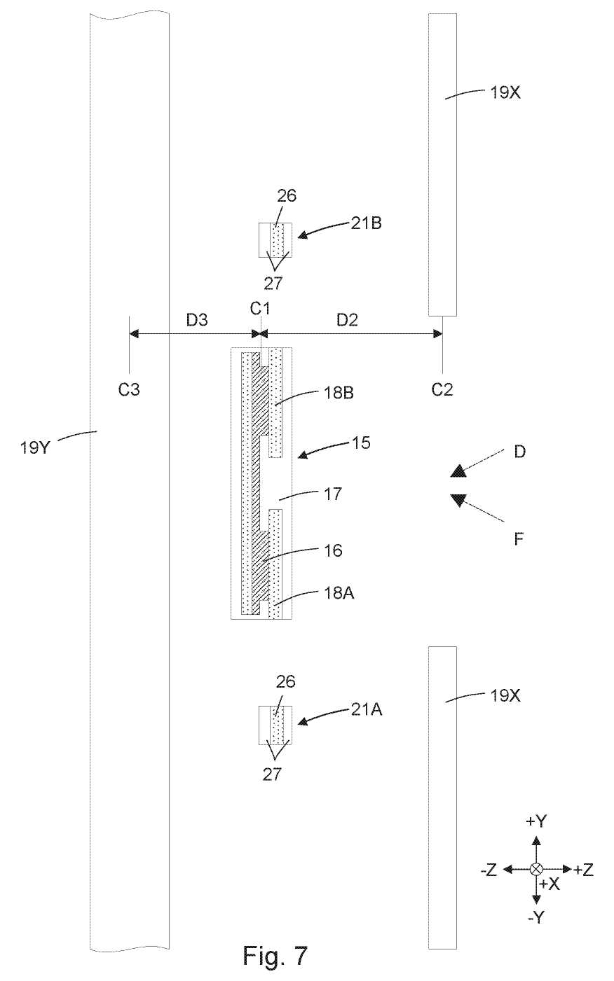

FIG. 4 is an enlarged view of area B in FIG. 2, FIG. 5 is a partial plan view of infrared sensor 2 viewed along line 5−5 of FIG. 4, FIG. 6A is a schematic cross-sectional view taken along line 6A−6A of FIG. 5, FIG. 6B is a schematic cross-sectional view taken along line 6B−6B of FIG. 5, FIG. 6C is a schematic cross-sectional view taken along line 6C−6C of FIGS. 5, and 7 is an enlarged view of area C in FIG. 6B. In FIG. 4, first arm parts 21A and second arm parts 21B are not shown. In FIG. 4, five infrared detection elements 15 are arranged in the Y-direction, but as mentioned above, the number of infrared detection elements 15 is not limited. The positions of infrared detection elements 15, first arm parts 21A, second arm parts 21B, first columnar bodies 25A and second columnar bodies 25B in the Z-direction are between the positions of first wirings 19X in the Z-direction and second wirings 19Y in the Z-direction. In FIG. 5, these are shown as solid lines.

Infrared sensor 2 comprises first wirings 19X that extend in the X-direction and second wirings 19Y that extend in the Y-direction. As shown in FIG. 4, first wirings 19X and second wirings 19Y are supported by second substrate 12. First wirings 19X are provided on second substrate 12 and second wirings 19Y are provided at a distance in the −Z-direction from second substrate 12. First wirings 19X may be provided via an insulating film between first wirings 19X and second substrate 12. In the Z-direction, first wirings 19X are on the side of incidence (+Z-direction side) of incident infrared rays to be detected (electromagnetic waves to be detected) with respect to infrared detection elements (electromagnetic wave detection elements) 15. In other words, the positions of first wirings 19X in the Z-direction are more toward the incident side (+Z-direction side) of the target infrared rays (target electromagnetic wave) to be detected than the positions of infrared detection elements (electromagnetic wave detection elements) 15 in the Z-direction. In the Z-direction, infrared detection elements (electromagnetic wave detection elements) 15 are positioned between first wirings 19X and second wirings 19Y. In other words, the positions of infrared detection elements (electromagnetic wave detection elements) 15 in the Z-direction are between the positions of first wirings 19X in the Z-direction and the positions of second wirings 19Y in the Z-direction. Second wirings 19Y are positioned on the −Z-direction side from infrared detection elements 15. In other words, the positions of second wirings 19Y in the Z-direction are on the −Z-direction side from the positions of infrared detection elements 15 in the Z-direction. First wirings 19X and second wirings 19Y are electrically connected to the ROICs of first substrate 11 by electrical connection members (not shown). First wirings 19X and second wirings 19Y can be made of metals such as Al, Cu, Au, and Ag, alloys mainly composed of these metals, or conductive nitrides such as TiN, ZrN, WN, and CrN.

As shown in FIG. 5, each infrared detection element 15 is connected to first arm part 21A and second arm part 21B that support infrared detection element 15. As shown in FIG. 7, each infrared detection element 15 includes temperature detection film 16, dielectric layer 17, first electrode layer 18A, and second electrode layer 18B. Temperature detection film 16 is formed of, for example, a thermistor film, and the thermistor film may include, for example, at least one of vanadium oxide, amorphous silicon, polycrystalline silicon, oxides with spinel-type crystal structures containing manganese, titanium oxide, yttrium-barium-copper oxide, and nanocarbon materials such as graphene or carbon nanotubes. Temperature detection film 16 may be a thermocouple film, a thermopile film, a diode film such as a silicon diode, or a pyroelectric film such as a lead zirconate titanate film. Dielectric layer 17 covers at least a portion of temperature detection film 16 and absorbs the infrared rays to be detected. Infrared detection element 15 may be a form in which dielectric layer 17 that covers temperature detection film 16 is omitted and in which temperature detection film 16 absorbs the infrared rays to be detected. The infrared rays to be detected that are absorbed by dielectric layer 17 and temperature detection film 16 of infrared detection element 15 are converted into heat, and change in the intensity of the infrared rays to be detected is detected by temperature detection film as a change in temperature. Each first arm part 21A and second arm part 21B comprises conductive wiring layer 26 and dielectric films 27 that sandwich conductive wiring layer 26 in the Z-direction. First electrode layer 18A is electrically connected to temperature detection film 16 and to conductive wiring layer 26 of first arm part 21A, and second electrode layer 18B is electrically connected to temperature detection film 16 and to conductive wiring layer 26 of second arm part 21B. First electrode layer 18A and second electrode layer 18B supply temperature detection film 16 with a current that flows in the in-plane direction (XY plane) of temperature detection film 16. Although not shown, another electrode layer that has portions that overlap with first electrode layer 18A and second electrode layer 18B as viewed in the Z-direction may be provided on the surface of temperature detection membrane 16 that is opposite in the Z-direction from the surface on which first electrode layer 18A and second electrode layer 18B are provided. In this case, current flows through temperature detection film 16 in the direction of film thickness (the Z-direction).

As shown in FIGS. 6A and 6C, infrared sensor 2 comprises conductive first pillar portions 22A and second pillar portions 22B that are columnar and conductive. First and second pillar portions 22A and 22B extend in a direction that includes at least a component in the Z-direction (in the present embodiment, the Z-direction). Each first pillar portion 22A is electrically connected to conductive wiring layer 26 and corresponding one first wiring 19X of first arm part 21A, and second pillar portion 22B is electrically connected to conductive wiring layer 26 and corresponding one second wiring 19Y of second arm part 21B. In other words, each individual infrared detection element 15 is electrically connected to corresponding one first wiring 19X via first pillar portion 22A and to corresponding one second wiring 19Y via second pillar portion 22B. As a result, DC current flows between infrared detection element 15 (temperature detection membrane 16) and first wiring 19X via first pillar portion 22A and flows between infrared detection element 15 (temperature detection membrane 16) and second wiring 19Y via second pillar portion 22B. In the present embodiment, DC current flows in the order of (or in the reverse order of) first wiring 19X, first pillar portion 22A, conductive wiring layer 26 of first arm part 21A, temperature detection film 16 of infrared detection element 15, conductive wiring layer 26 of second arm part 21B, second pillar portion 22B, and second wiring 19Y. First pillar portion 22A both supports first arm part 21A and supports infrared detection element 15 via first arm part 21A. Second pillar portion 22B both supports second arm part 21B and supports infrared detection element 15 via second arm part 21B.

First insulation layer 23A is provided between first pillar portion 22A and second wiring 19Y to electrically insulate first pillar portion 22A and second wiring 19Y. This configuration prevents DC current from flowing between first pillar portion 22A and second wiring 19Y. First intermediate layer 24A is provided between first insulation layer 23A and second wiring 19Y. Second insulation layer 23B is provided between second pillar portion 22B and first wiring 19X to electrically insulate second pillar portion 22B and first wiring 19X. This configuration prevents DC current from flowing between second pillar portion 22B and first wiring 19X. Second intermediate layer 24B is provided between second insulation layer 23B and first wiring 19X. First intermediate layer 24A and second intermediate layer 24B are formed from a conductor but may also be formed from an insulator. First pillar portion 22A, first insulation layer 23A, and first intermediate layer 24A constitute first columnar body 25A that extends in the Z-direction from first wiring 19X to second wiring 19Y, and these layers support second wiring 19Y. Second pillar portion 22B, second insulation layer 23B, and second intermediate layer 24B constitute second columnar body 25B that extends in the Z-direction from first wiring 19X to second wiring 19Y, and these layers support second wiring 19Y. First pillar portion 22A, first insulation layer 23A, and first intermediate layer 24A are cylindrical or disc-shaped and concentric with each other, but these shapes are not limited. Similarly, second pillar portion 22B, second insulation layer 23B, and second intermediate layer 24B are cylindrical or disc-shaped and concentric with each other, but these shapes are not limited.

### First Wirings 19X

The configuration of first wirings 19X is next described. First wirings 19X extend parallel in the X-direction. Referring to FIGS. 1A and 1B, infrared rays generated by detection target 51 such as a person or an object contain a component that is directly incident to infrared camera 1 (hereinafter referred to as “direct incident wave D”) as well as a component that is generated by the reflection of incident wave E on ground surface G and then incident to infrared camera 1 (hereinafter referred to as “reflected wave F”). Infrared detection elements 15 of infrared camera 1 absorb and detect the incident infrared rays but do not distinguish between direct incident wave D and reflected wave F. In other words, infrared detection elements 15 absorb both direct incident wave D and reflected wave F. However, the image obtained by reflected wave F is imaginary image 52 of detection target 51 and is not the original image of detection target 51. In addition, the image taken at a certain position G1 of ground surface G is an image of ground surface G superimposed on imaginary image 52, and the state of ground surface G consequently may not be properly understood. The accuracy of infrared camera 1 in detecting detection target 51 and in ascertaining the state of ground surface G can therefore be improved by reducing the number of reflected waves F incident to infrared detection elements 15.

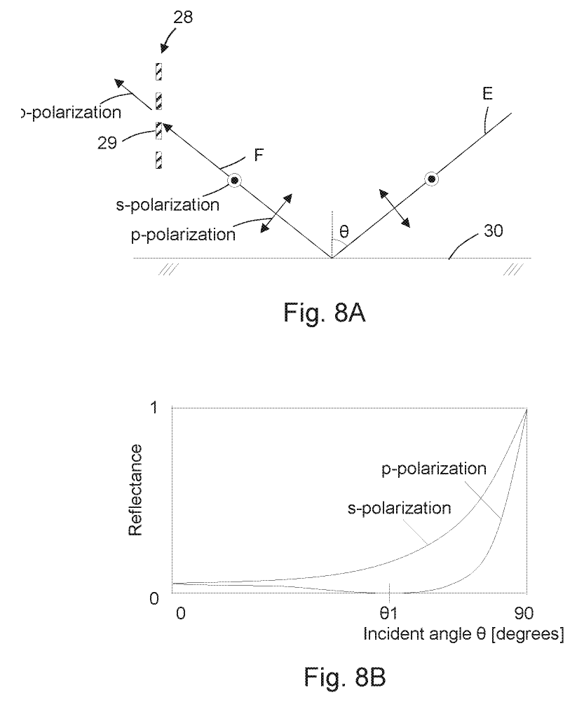

FIG. 8 shows the concept of infrared polarization and polarization filters. FIG. 8A conceptually shows incident wave E and reflected wave F produced by the reflection of incident wave E on reflecting surface 30 (corresponding to ground surface G in the present embodiment). In general, infrared rays include s-polarization and p-polarization. The direction of oscillation of the electric field of s-polarization is perpendicular to the surface of incidence (YZ plane), i.e., parallel to the reflecting surface 30 (XZ plane), and the direction of oscillation of the electric field of p-polarization is parallel to the surface of incidence. The direction of oscillation of the electric field of s-polarization is orthogonal to the direction of oscillation of the electric field of p-polarization. FIG. 8B shows an example of reflectance for s-polarization and p-polarization. As the incident angle θ shown in FIG. 8A is gradually increased from 0 degrees, the reflectance of p-polarization first decreases, reaches 0 at a certain angle θ1 (Brewster angle), and then increases. The reflectance of s-polarization increases monotonically with increase of incident angle θ. Thus, because s-polarization is dominant in reflected wave F, suppressing s-polarization incident to infrared detection elements 15 is effective for suppressing reflected wave F that is incident to infrared detection elements 15. As shown in FIG. 8A, the use of polarization filter 28 consisting of, for example, linear or plate-shaped metal members 29 that extend parallel to the X-direction can suppress the s-polarization incident to infrared detection elements 15. Polarization filter 28 of this type has the property of transmitting p-polarization but suppressing the transmission of s-polarization.

In the present embodiment, because infrared sensor 2 is configured such that the X-direction, the direction in which first wirings 19X extend, is parallel to ground surface G, and first wirings 19X can thus be used as a polarizing filter 28. In other words, each of first wirings 19X can be used as individual metal members 29 of polarization filter 28. As mentioned above, in infrared sensor 2 of the present embodiment, the number of columns C parallel to the Y-direction of infrared detection elements 15 is greater than the number of rows R parallel to the X-direction of infrared detection elements 15. Infrared sensor 2 is installed on a vehicle that can be driven, such as automobile 101 or two-wheel vehicle 102, such that the direction of extension of first wirings 19X, i.e., the X-direction that is the direction of extension of rows R, is parallel to ground surface G, whereby the reflected waves incident to infrared detection elements 15 can be reduced.

In the present embodiment, the wavelength of infrared rays from detection target 51 is mainly in the range of 8 to 14μm, and the transmittance of s-polarization with a wavelength of 8 to 14μm is therefore effectively lowered. Making the pitch of arrangement of metal members 29 of polarization filter 28 less than the wavelength of the infrared rays is effective from the viewpoint of decreasing the transmittance of s-polarization. Therefore, arrangement pitch D1 (the interval between center lines 19C that extend in the X-direction of mutually adjacent first wirings 19X) in the Y-direction of first wirings 19X shown in FIG. 5 can be 8μm or less. However, the transmittance of s-polarization does not increase significantly even if arrangement pitch D1 of first wirings 19X is greater than the wavelength of infrared rays, and the arrangement pitch D1 of first wirings 19X can therefore be 20μm or less or can even be 8μm or less to further reduce the transmittance of s-polarization. The lower limit of arrangement pitch D1 of first wirings 19X is not particularly limited but can be, for example, 3μm.

Although a portion of the s-polarization is blocked by first wirings 19X, the s-polarization that is blocked is also microscopically present within a range about the size of the wavelength of infrared rays from first wirings 19X to the infrared-detection-element-15 side (in the −Z-direction). The intensity of the s-polarization that is present within this range rapidly attenuates with increasing separation from first wirings 19X in the −Z-direction. Positioning infrared detection elements 15 away from first wirings 19X in the Z-direction is therefore effective for further reducing the s-polarization incident to infrared detection elements 15. For example, as shown in FIG. 7, when the spacing between center C1 in the Z-direction of each of infrared detection elements 15 and center C2 in the Z-direction of corresponding one of the first wirings 19X that are electrically connected to respective infrared detection elements 15 is D2, D2 can be 8 μm or more. Alternatively, when the spacing between center C1 in the Z-direction of each of infrared detection elements 15 and center C3 in the Z-direction of corresponding one of the second wirings 19Y that are electrically connected to respective infrared detection elements 15 is D3, D2 can be larger than D3.

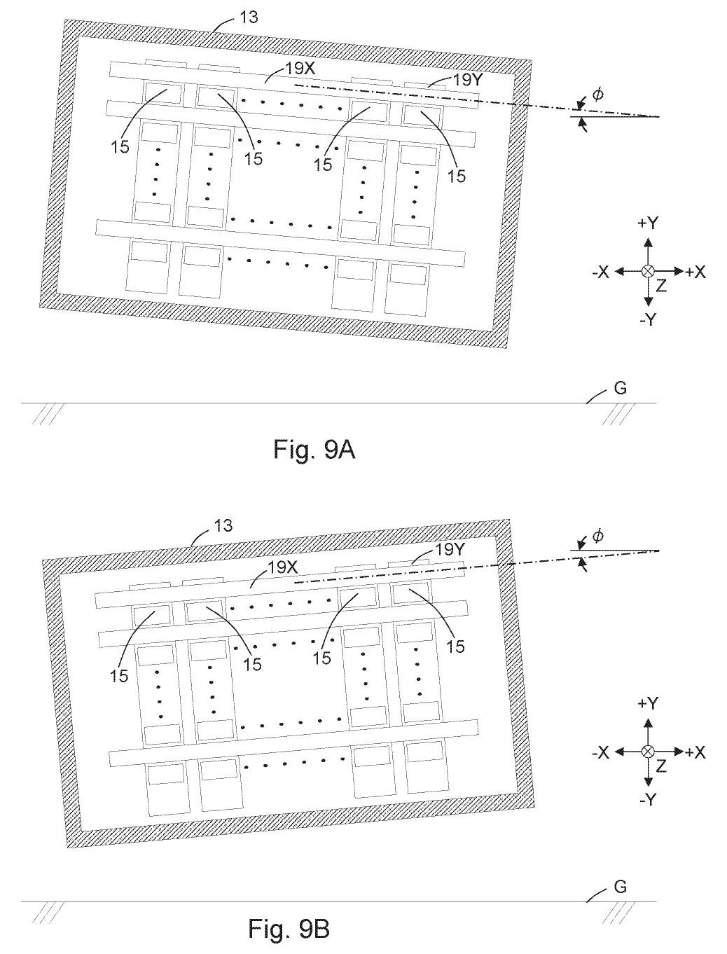

FIGS. 9A and 9B are cross-sectional views of infrared sensor 2 viewed along line 3−3 in FIG. 2 and show modifications of the present embodiment. As described above, setting the X-direction of infrared sensor 2, which is the direction in which first wirings 19X extend, parallel to ground surface G is effective for reducing the transmittance of s-polarization. However, due to error when mounting infrared sensor 2 on automobile 101 or two-wheeled vehicle 102, and space limitations for accommodating infrared sensor 2 in automobile 101 or two-wheeled vehicle 102, the X-direction of the infrared sensor, which is the direction in which first wirings 19X extend, may be tilted (non-parallel) with respect to ground surface G. In the example shown in FIG. 9A, infrared sensor 2 is tilted in a clockwise direction relative to the embodiment shown in FIG. 3, and in the example shown in FIG. 9B, infrared sensor 2 is tilted in a counterclockwise direction relative to the embodiment shown in FIG. 3. As a result, the X-direction, which is the direction in which first wirings 19X extend, is tilted with respect to ground surface G. However, the effect of reducing transmission of the s-polarization of the reflected waves is obtained even if the X-direction, which is the direction in which first wirings 19X extend, is slightly tilted with respect to ground surface G. The tilt angle φ of the X-direction, which is the direction in which first wirings 19X extend, with respect to ground surface G may be within a range of, for example, 0 degrees or more to 5 degrees or less.

In consideration of the present embodiment and the modifications, infrared sensor 2 of the present embodiment may be configured such that the X-direction, which is the direction in which first wirings 19X extend, is approximately parallel to ground surface G (within a range of tilt of 5 degrees or less with respect to ground surface G). In other words, because the direction of extension of axles 106 (FIGS. 1A and 1B) that rotatably support wheels 105 of moveable machine 100 such as automobile 101 or two-wheeled vehicle 102 is parallel to ground surface G, infrared sensor 2 of the present embodiment may be configured such that the X-direction, which is the direction in which first wirings 19X extend, is roughly parallel to the direction of extension of axles 106 (within a range of tilt of 5 degrees or less with respect to the direction of extension of axles 106).

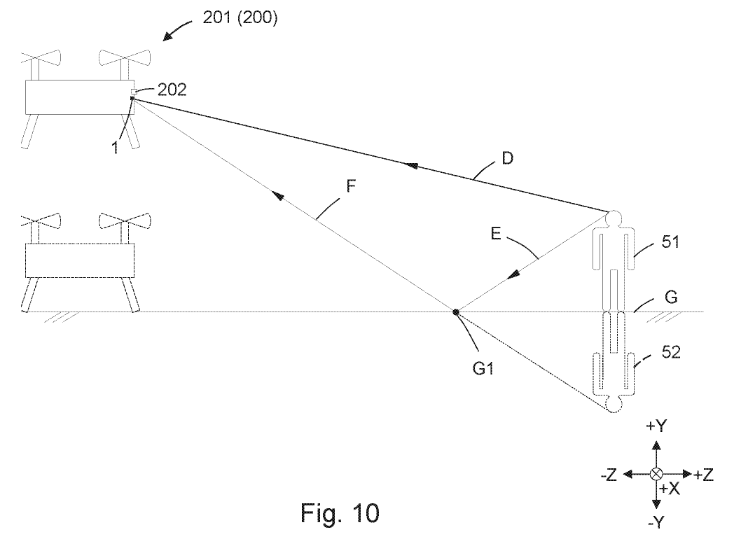

FIG. 10 shows a schematic side view of flyable machine 200 on which infrared camera 1 provided with infrared sensor 2 of the present embodiment is mounted. Although FIG. 10 shows drone 201 as an example of flyable machine 200, flyable machine 200 is not limited to a drone, but may also be a helicopter or a vertical takeoff and landing aircraft such as an electric vertical takeoff and landing pilotless aircraft. In other words, flyable machine 200 may be a vertical takeoff and landing flyable machine 200. Infrared sensor 2 is located on the surface of drone 201 on which camera 202 is mounted. Infrared sensor 2 and camera 202 may be housed together in housing 4. When operated by a human operator as in a helicopter, infrared sensor 2 can be provided on the front panel on the pilot’s side. Infrared sensor 2 of the present embodiment is configured such that the X-direction, which is the direction in which first wirings 19X extend, is roughly parallel to ground surface G when drone 201 is landed on ground surface G before the start of flight (shown by dotted lines in the drawing). Drones 201, helicopters, and vertical takeoff and landing aircraft such as electric vertical takeoff and landing pilotless aircraft spend much of their time in flight in the same orientation as when landed on ground surface G before the start of flight. In other words, these flyable machines 200 typically take off from ground surface G and spend much of their time in flight in an attitude parallel to ground surface G. Therefore, infrared sensor 2 on drone 201 operates in the same manner as infrared sensor 2 on automobile 101 described above, and the reflected waves incident to infrared detection elements 15 can be reduced.

Although certain embodiments of the present disclosure have been illustrated and described in detail, it will be understood that various changes and modifications can be made therein without departing from the spirit or scope of the appended claims.

### LIST OF REFERENCE NUMERALS

2 infrared sensor (electromagnetic sensor)
15 infrared detection element (electromagnetic wave detection element)
19X first wiring
19Y second wiring
100 moveable machine
101 automobile
102 two-wheeled vehicle
200 flyable machine
201 drone
G ground surface
X first direction
Y second direction
Z third direction

1. An electromagnetic wave sensor comprising:
first wirings that extend in a first direction;
second wirings that extend in a second direction that is different from the first direction; and
bolometers, wherein
each of the bolometers is electrically connected to one of the first wirings and one of the second wirings,
in a third direction that is orthogonal to the first and second directions, the first wirings are on a side of incidence of incident electromagnetic waves with respect to the bolometers, and positions of the bolometers in the third direction are between positions of the first wirings in the third direction and positions of the second wirings in the third direction, and
the electromagnetic wave sensor is configured such that a direction in which the first wirings extend is substantially parallel to a ground surface.

2. The electromagnetic wave sensor according to claim 1, wherein the first wirings are arranged at an arrangement pitch of 3μm or more to 20μm or less.

3. The electromagnetic wave sensor according to claim 1, wherein
the bolometers are arranged in an array arrangement having rows parallel to the first direction and columns parallel to the second direction, and
the number of the columns is greater than the number of the rows.

4. The electromagnetic wave sensor according to claim 1, wherein
spacing between a center in the third direction of each of the bolometers and a center in the third direction of corresponding one of the first wirings that are electrically connected to the respective bolometers is 8μm or more.

5. The electromagnetic wave sensor according to claim 1, wherein
spacing between a center in the third direction of each of the bolometers and a center in the third direction of corresponding one of the first wirings that are electrically connected to the respective bolometers is greater than spacing between the center in the third direction of each of the bolometers and a center in the third direction of corresponding one of the second wirings that are electrically connected to the respective bolometers.

6. An electromagnetic wave sensor comprising:
first wirings that extend in a first direction;
second wirings that extend in a second direction that is different from the first direction; and
bolometers, wherein
each of the bolometers is electrically connected to one of the first wirings and one of the second wirings,
in a third direction that is orthogonal to the first and second directions, the first wirings are on a side of incidence of incident electromagnetic waves with respect to the bolometers, and positions of the bolometers in the third direction are between positions of the first wirings in the third direction and positions of the second wirings in the third direction,
the bolometers are arranged in an array arrangement having rows parallel to the first direction and columns parallel to the second direction, and
the number of the columns is greater than the number of the rows.

7. The electromagnetic wave sensor according to claim 6, wherein
spacing between a center in the third direction of each of the bolometers and a center in the third direction of corresponding one of the first wirings that are electrically connected to the respective bolometers is 8μm or more.

8. The electromagnetic wave sensor according to claim 6, wherein
spacing between a center in the third direction of each of the bolometers and a center in the third direction of corresponding one of the first wirings that are electrically connected to the respective bolometers is greater than spacing between the center in the third direction of each of the bolometers and a center in the third direction of corresponding one of the second wirings that are electrically connected to the respective bolometers.

9. A moveable machine comprising the electromagnetic wave sensor according to claim 1.

10. An automobile comprising the electromagnetic wave sensor according to claim 1.

11. A two-wheeled vehicle comprising the electromagnetic wave sensor according to claim 1.

12. A flyable machine comprising the electromagnetic wave sensor according to claim 1.

13. A moveable machine comprising:
a wheel;
an axle that rotatably supports the wheel; and
an electromagnetic wave sensor, wherein
the electromagnetic wave sensor comprises:
first wirings that extend in a first direction;
second wirings that extend in a second direction that is different from the first direction; and
bolometers, wherein
each of the bolometers is electrically connected to one of the first wirings and one of the second wirings,
in a third direction that is orthogonal to the first and second directions, the first wirings are on a side of incidence of incident electromagnetic waves with respect to the bolometers, and positions of the bolometers in the third direction are between positions of the first wirings in the third direction and positions of the second wirings in the third direction, and
the electromagnetic wave sensor is configured such that a direction in which the first wirings extend is substantially parallel to the axle.

14. An electromagnetic wave sensor comprising:
first wirings that extend in a first direction;
second wirings that extend in a second direction that is different from the first direction; and
electromagnetic wave detection elements that absorb and detect incident electromagnetic waves, wherein
each of the electromagnetic wave detection elements is electrically connected to one of the first wirings and one of the second wirings,
in a third direction that is orthogonal to the first and second directions, the first wirings are on a side of incidence of incident electromagnetic waves with respect to the electromagnetic wave detection elements, and positions of the electromagnetic wave detection elements in the third direction are between positions of the first wirings in the third direction and positions of the second wirings in the third direction, and
the electromagnetic wave sensor is configured such that a direction in which the first wirings extend is substantially parallel to a ground surface.

15. An electromagnetic wave sensor comprising:
first wirings that extend in a first direction;
second wirings that extend in a second direction that is different from the first direction; and
electromagnetic wave detection elements that absorb and detect incident electromagnetic waves, wherein
each of the electromagnetic wave detection elements is electrically connected to one of the first wirings and one of the second wirings,
in a third direction that is orthogonal to the first and second directions, the first wirings are on a side of incidence of incident electromagnetic waves with respect to the electromagnetic wave detection elements, and positions of the electromagnetic wave detection elements in the third direction are between positions of the first wirings in the third direction and positions of the second wirings in the third direction,
the electromagnetic wave detection elements are arranged in an array arrangement having rows parallel to the first direction and columns parallel to the second direction, and
the number of the columns is greater than the number of the rows.

16. A moveable machine comprising:
a wheel;
an axle that rotatably supports the wheel; and
an electromagnetic wave sensor, wherein
the electromagnetic wave sensor comprises:
first wirings that extend in a first direction;
second wirings that extend in a second direction that is different from the first direction; and
electromagnetic wave detection elements that absorb and detect incident electromagnetic waves, wherein
each of the electromagnetic wave detection elements is electrically connected to one of the first wirings and one of the second wirings,
in a third direction that is orthogonal to the first and second directions, the first wirings are on a side of incidence of incident electromagnetic waves with respect to the electromagnetic wave detection elements, and positions of the electromagnetic wave detection elements in the third direction are between positions of the first wirings in the third direction and positions of the second wirings in the third direction, and
the electromagnetic wave sensor is configured such that a direction in which the first wirings extend is substantially parallel to the axle.
